(19) United States
(12) Patent Application Publication
(10) Pub. No.: US 2003/0057374 A1
(43) Pub. Date: Mar. 27, 2003

(54) Switchable infrared radiation analysis method and device

(75) Inventors: Reiner Schuebel, Durmersheim (DE); Arno Simon, Karlsruhe (DE); Michael Juette, Karlsruhe (DE)

Correspondence Address: Kohler Schmid & Partner, Patentanwalte, Ruppmannstrasse 27, Stuttgart, D-70565, DE

(73) Assignee: Bruker Optik GmbH, Ettlingen (DE)

(21) Appl. No.: 10/197,426

(22) Filed: Jul. 18, 2002

Related U.S. Application Data
(63) Continuation of application No. 09/580,406, filed on May 30, 2000.

(51) Int. Cl. G01N 21/35

(52) U.S. Cl. 250/339.08

(57) ABSTRACT

A switchable infrared radiation method and device provides for optical analysis of a sample using a Fourier transform spectrometer for illumination thereof. A housing accommodates an optical delineation means mounted therein which transmits infrared radiation following interaction with the sample. The radiation is passed through an optical switch mounted in the housing having a first switching position and a second switching position for reflecting infrared radiation transmitted by the optical delineation means. A single element detector is mounted in the housing for detecting infrared radiation transmitted by the optical switch in its first switching position. An array detector is also mounted in the housing to accept radiation from the optical switch in the second switching position. The array detector comprises a plurality of pixel-like infrared sensors for two-dimensional detection of the radiation. A signal analyzer communicates with both the single element detector and the array detector for analyzing single element detector signals as well as for analyzing array detector signals. The analysis system of the invention incorporates the advantages of both the single element detector system as well those of the array detector system, in a single device, thereby allowing the user to avoid the disadvantages of both systems. In this manner samples can be examined in a minimum amount of time with a desirable degree of spectral sensitivity and spatial precision.

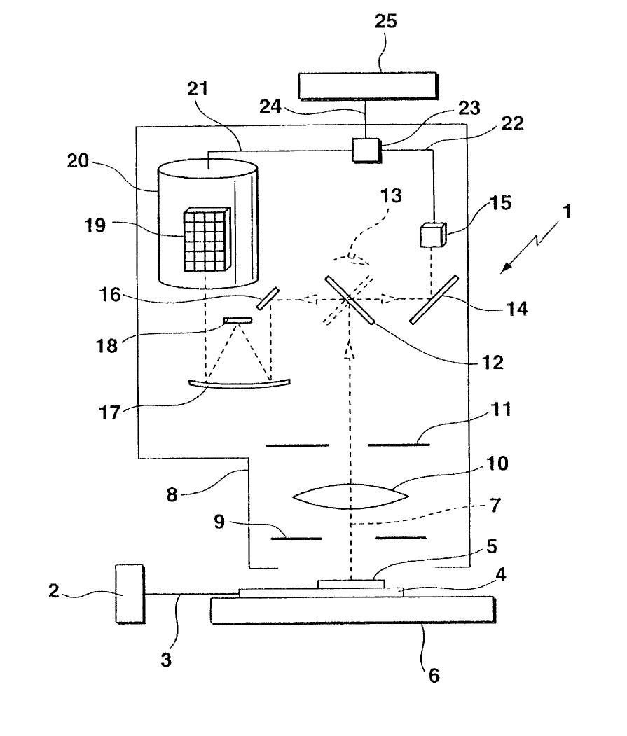

This application is a continuation of Ser. No. 09/580,406 filed on May 30, 2000 the entire disclosure of which is hereby incorporated by reference.

### BACKGROUND OF THE INVENTION

The invention concerns a switchable infrared radiation analysis method and device for optical analysis of a sample through irradiation with a Fourier transform infrared spectrometer. Preferred applications include infrared microscopes. Applications involving macroscopic imaging are also preferred.

Method and devices of this type are often used to investigate samples having sizes between 25 to 100 mm². Spatial resolution is required in order to scan and investigate small portions of the sample on the order of 5×5 μm to 60×60 μm in size. This can be effected using a displaceable stage for the sample which can be translated to arbitrary positions in two dimensions (i.e. x-y). Apertures are disposed in the optical path to define the portion of the sample to be detected and investigated. After interaction with the sample, the infrared radiation is transported to a single element detector having an active size of typically 250 μm×250 μm. The detected signals are then passed to an analysis device such as an FT (Fourier transform) signal analyzer. In this manner, absorption spectroscopic analysis of selected portions of the sample can be carried out in the infrared spectral region.

This procedure has the disadvantage that scanning of the sample through stepwise displacement of the stage is very time consuming. Recently, focal plane array detection systems have been implemented which operate in a manner similar to that of CCD's (charge couple devices) for visible range radiation. These devices comprise a two-dimensional array of sensitive elements typically having a diameter of 60 μm per pixel. The arrays are capable of imaging samples on the order of 5 to 10 mm in size in a single experiment without requiring two-dimensional translation of the sample using a translating stage. Disadvantageously, these detection systems are very expensive (on the order of $ 50,000) and have limited spectral sensitivity. For example, so-called MCT detectors have a spectral range of 10,5 μm to 2 μm and InSb detectors a spectral sensitivity in the range of 5,5 μm to 1 μm. InGaAs detectors have a spectral sensitivity in the range of 1.7 μm to 0.8 μm. This can be compared to the sensitivity of single element MCT detectors having a range of 16.6 to 2 μm.

Due to the above mentioned status of prior art it is the underlying purpose of the invention to introduce an infrared radiation analysis method and device for optical analysis of a sample which avoids the disadvantages of both the single element detection and of the focal plane array detection methods.

### SUMMARY OF THE INVENTION

This purpose is achieved in accordance with the invention with a method and device for spectroscopic infrared analysis of defined and selected spatial regions of a sample using a Fourier transform infrared spectrometer, the sample disposed in a housing in which a two-dimensional array detector, a single element detector and an optical switch are also disposed, the optical switch for directing infrared radiation emanating from the sample onto either the array detector or the single element detector. The method and device comprise the following steps and means for their execution:

a) irradiating at least one spatial position of the sample with encoded infrared radiation generated by the Fourier transform infrared spectrometer;

b) setting the optical switch to direct infrared radiation from the sample onto the single element detector;

c) passing single element detector signals to a Fourier transforming signal analyzer for spectral analysis of the sample;

d) evaluating step c) to decide whether or not further measurements with the two-dimensional array detector should be carried out, and if so proceeding to step e);

e) switching the optical switch to direct infrared radiation emanating from the sample onto the array detector; and

f) passing pixel by pixel array detector signals to the Fourier transforming signal analyzer for spectroscopic analysis of the sample in two spatial dimensions.

In accordance with the invention, an initial rapid analysis of the sample can be carried out at one or more spatial positions using the single element detector. Should these results indicate a need for a full two-dimensional scan then such a scan can be carried out by switching over to the array detector. Although the subsequent array detector measurements are more time consuming than the single element detector measurements at only one spatial position in the sample, they are much faster then a full step by step spatial scan of the respective field of view using the single element detector. Therefore, by combining both the array detector and the single element detector in a single instrument and by providing means for switching optical radiation from the sample to be incident upon each of the single element detector element and the detector array, the invention effectively avoids the disadvantages of each of the two detection techniques by allowing the user to switch the system to that detector which is most advantageous for the particular measurement at hand. Should the spectral sensitivity of the single element detector be more important than the increased time required to make a full two dimensional measurement with the single element detector, the single element detector can also be used instead of the array detector for measurements in two spatial dimensions. On the other hand, if the mechanical translation of the sample requires an excessive amount of time, and if the spectral sensitivity is adequate, the optical switching means is selected to direct radiation from the sample onto the array detector for cases in which full two dimensional spectral information is desired. In this manner, the advantages of each of the detector systems are maintained while the disadvantages of both are avoided. Samples can be scanned in a minimum amount of time with a desired degree of spectral sensitivity.

In a preferred embodiment, the method and device comprise signal switching means connected between a signal analyzer and the array detector and connected between the signal analyzer and the single element detector for transmitting the array detector signals or the single element detector signals to the signal analyzer. This embodiment has the advantage of providing a single interface between the detector and analyzer systems which can be switched either manually or by computer control to direct the analysis system to access either signals from the individual detector element or from the array detector.

In a further embodiment, the method and device comprise a translation staging means for horizontal translation of the sample relative to the housing. This embodiment facilitates use of the single element detector for scanning a sample over a wide area through movement of the translation stage means in a horizontal plane. Alternatively, should the array detector be used, the translation stage means can remain stationary.

In a further embodiment, the optical switch comprises a substantially planar mirror and means for pivoting the mirror to reflect the infrared radiation to a first side of said housing in the first switching position and to a second side of the housing in a second switching position. This embodiment has the advantage that the optical switch simply maps the image to either one or the other side of the housing without influencing the imaging optics. Reflection to opposite sides of the housing provide space for the associated single detector element as well as for the detector array system. A simple pivoting mechanism mounted to the essentially planar mirror provides for a simple and reliable deflection of the beam which can be effected either manually or through computer control.

In an improvement of this embodiment, the housing and the optical delineation means define an infrared microscope with a mirror objective. Preferably, the mirror objective is a Cassegrain objective. This improvement has the advantage of using established technology and optical systems incorporated into the device in accordance with the invention to assure reliable and high quality performance.

In a further improvement, the optical delineation means comprise collimating means and focussing means. This embodiment has the advantage of providing improved definition of the beam to optimize optical transport of the beam to the detection means while avoiding unwanted regions of the sample.

In a further embodiment of the invention, single element detector focussing means are provided disposed in a first optical path between the optical switching means and the single element detector for focussing infrared radiation onto the single element detector. This measure facilitates mapping of the active field of view, as selected by the optical delineation means, onto the single element detector such that the single element detector must not be precisely equal in size to the portion of the sample being measured.

In an additional preferred embodiment, array detector focussing means are disposed in the second optical path between the optical switch and the array detector for focussing infrared radiation onto the array detector. This measure has the advantage that the sensitive area of the array detector can be properly used such that the active field of view can be optically mapped to the size of a particular array detector.

In an improvement of this embodiment, the array detector focussing means define an Ofner telescope. This improvement has the advantage of using established technology to properly introduce the infrared radiation onto the detector array to optimize sensitivity and resolution.

In a preferred embodiment, cryogenic means are provided in thermal contact with the array detector. This measure has the advantage of increasing the signal to noise ratio of the detector by suppressing thermal noise.

In an improvement in this embodiment, the cryogenic means comprise a liquid nitrogen vessel. This measure has the advantage of using established technology at low cost to substantially increase the signal-noise ratio by cooling the detector to liquid nitrogen temperatures.

In a preferred embodiment, the array detector comprises at least one of an MCT-detector, an InSb-detector, and an InGaAs detector. This measure has the advantage of providing different spectral range sensitivities for various optical regions of the radiation spectra under investigation using established detector technology.

In a preferred embodiment, the single element detector comprise an MCT detector. This measure has the advantage of providing a detector device having good spectral sensitivity over the infrared radiation range of interest.

In a preferred embodiment, the signal analyzer comprises means for macroscopic imaging. This measure has the advantage of using the optical system and the detection system not only for microscopic evaluation of portions of the sample but for global infrared imaging of large portions of the sample either using the array device or by stepping through the sample using single element detection. The sample can therefore be “seen” in the infrared region.

In a preferred embodiment, the array detector comprises a first array detector with a first spectral sensitivity and a second array detector with a second spectral sensitivity. This measure has the advantage of providing two detector arrays within the instrument which can be switched for use in dependence on the spectral sensitivity desired. Appropriate optical means can be introduced in the optical path between the switching mirror and the respective array detector to introduce the optical radiation to the respective array detector. Alternatively, means can be provided for removing one array detector from the housing and replacing it with another array detector in a simple and straightforward fashion.

In a preferred alternative embodiment of the method and device according to the invention, the sample is first examined using the array detector and, following analysis of this examination, a decision is taken as to whether on not further studies should be carried out using the single element detector. This could be the case should the initial studies using the array detector indicate that the improved spectral sensitivity of the single element detector is important. Two dimensional information at such improved sensitivity could also be obtained with the single element detector through conventional displacement of the sample.

Further details of the invention are described through detailed discussion of a preferred embodiment discussed below in relation to the FIGURE. The individual features of the invention can be important either alone or in arbitrary mutual combination. The embodiment shown has exemplary character and is not an exhaustive disclosure of all configurations related to the invention.

### BRIEF DESCRIPTION OF THE DRAWING

The sole FIGURE shows a schematic sketch of a preferred embodiment of the analysis device in accordance with the invention.

### DESCRIPTION OF THE PREFERRED EMBODIMENT

In this preferred embodiment, the infrared analysis device, indicated in its entirety with reference symbol 1, comprises an infrared generation and analysis means 2. The infrared generation and analysis means 2 comprises a Fourier transform infrared spectrometer. An infrared beam from the spectrometer is transmitted through appropriate infrared radiation transport means 3 to a sample illuminator 4 for illumination of a sample 5. The sample illuminator 4 can be any appropriate material or means for transporting infrared radiation for illumination to the sample 5, such as an ATR crystal or the like. If appropriate, the infrared radiation transport means 3 can be eliminated, and the Fourier transform spectrometer 2 can directly irradiate the sample illuminator 4. In other embodiments, the Fourier transform spectrometer 2 is adapted to radiate the sample 5 from an upward direction and not from below. The embodiment illustrated in the FIGURE would be appropriate for infrared absorption spectroscopy examination of the sample 5. However other types of infrared investigation could be easily performed with the device as are familiar to one of average skill in the art.

The sample illuminator 4 and the sample 5 are disposed on a translation stage 6. The translations stage 6 enables two dimensional translation of the sample in a horizontal plane (plane perpendicular to the drawing containing the sample 5). If required, vertical positioning can also be provided using the translation stage 6. After passing though the sample 5, an infrared radiation beam 7 is transmitted into a housing 8 of the infrared analysis device 1. The housing 8 accommodates first beam definition means 9, beam focussing means 10, and second beam definition means 11. For embodiments in which the infrared analysis device is a microscope, the first beam definition means 9, the first beam focussing means 10 and the second beam definition means 11 schematically indicate conventional optical focussing and collimating devices used in such instruments. The particular configuration shown in the drawing is schematic only and does not necessarily require that all of these elements be present in the configuration shown. After optical definition by the first beam definition means 9, the beam focussing means 10 and the second beam definition means 11, the beam 7 is incident on a switching mirror 12. The switching mirror 12 comprises switching means 13 for directing the beam 7 to the left or to the right as shown in the FIGURE. When the switching means 13 is in the position indicated by dashed lines, the beam 7 is directed towards the right in the FIGURE and is incident on a first focussing means 14. The first focussing means 14 passes the beam, after optical definition thereof, to a single element detector 15. Alternatively, should the switching mirror 12 be in the position indicated by the solid lines, the beam 7 is directed towards the left in the drawing. In this configuration of the switching means 13, the beam 7 is incident upon a deflection mirror 16 and passes therefrom onto a first focussing mirror 17, a second focussing mirror 18 and is reflected back onto the first focussing mirror 17 to pass to an array detector 19. The deflection mirrors 16, the first focussing mirror 17 and the second focussing mirror 18 are schematically indicated to provide means for transporting the infrared radiation and the beam 7 from the switching mirror 12 to the array detector 19. Any other suitable conventional means could be used to perform this function. The configuration shown corresponds schematically to that of a so-called Ofner telescope.

The array detector 19 is disposed in a dewar 20. The dewar 20 can contain liquid nitrogen to cool the array detector 19 down to liquid nitrogen temperature for improvement of the signal to noise ratio. The detector 19 has a signal cable 21 for transporting signals from the array detector. The array detector signal transport means 21 is connected to a signal switcher 23. The signal switcher 23 is also connected, via single element signal transport means 22, to the single element detector 15. The signal switcher 23 can be used to direct either the signals from the single element detector 15 or from the array detector 19, via a switched signal transport means 24, to an input of a signal analyzer 25, i.e. a computer with appropriate front end electronics. Operation of this system for Fourier transform spectroscopy is described below.

Should a user desire investigation of a sample, the user positions the sample 5 on the sample illuminator 4 and the translation stage 6. The Fourier transform spectrometer 2 is activated to transport infrared radiation via infrared transport means 3 and the sample illuminator 4 onto the sample 5. Should a scan using a single detector element array be desired, the switching means 13 is activated such that the switching mirror is positioned to direct the beam 7 coming from the sample 5 onto the single element detector 15 via the first focussing means 14. The signal switcher 23 is set to direct signals coming from the signal element detector 15, via the single element signal transport means 22, to signal analyzer 25. Spectral analysis for the particular position of the sample 5 is then performed. In possible subsequent steps, the translation stage 6 is optionally translated in a horizontal direction to the next position to be examined and a new measurement is performed. These steps are repeated until the entire desired sample surface is scanned.

Alternatively, the system can be used to scan the entire active surface of the sample in one step. In this case, the translation stage is positioned such that the field of view of interest is centered on the sample. The switching means is activated to switch the switching mirror 12 into the position intended for directing radiation from the sample towards the array detector 19. The array detector 19 is activated and used to detect radiation coming from the sample 5 and to pass signals generated by the array detector 19, via array signal transport means 21, to the signal switcher 23. The signal switcher 23 is set to receive the signal from the array detector and to pass these signals, via the switched signal transport means 24, to the signal analyzer 25. Spectroscopic investigation of the entire sample is then facilitated by pixel by pixel readout of the array detector which is either buffered for further processing or is processed, at least in part, in real time.

We claim:

1. A method for spectroscopic infrared analysis of defined and selected spatial regions of a sample using a Fourier transform infrared spectrometer, the sample disposed in a housing in which a two-dimensional array detector, a single element detector and an optical switch are also disposed, the optical switch for directing infrared radiation emanating from the sample onto either the array detector or the single element detector, the method comprising the steps of:
a) irradiating at least one spatial position on the sample with encoded infrared radiation generated by the Fourier transform infrared spectrometer;
b) setting the optical switch to direct infrared radiation from the sample onto the single element detector;
c) passing single element detector signals to a Fourier transforming signal analyzer for spectral analysis of the sample;
d) evaluating step c) to decide whether or not further measurements with the two-dimensional array detector should be carried out, and if so proceeding to step e);
e) switching the optical switch to direct infrared radiation emanating from the sample onto the array detector; and
f) passing pixel by pixel array detector signals to the Fourier transforming signal analyzer for spectroscopic analysis of the sample in two spatial dimensions.

2. A device for Fourier transform infrared spectroscopic analysis of defined and selected spatial regions of a sample using the method of claim 1, the sample disposed in a housing in which a two-dimensional array detector, a single element detector and an optical switch are also disposed, the optical switch for directing infrared radiation emanating from the sample onto either the array detector or the single element detector, the device comprising:
means for irradiating at least one spatial position on the sample with encoded infrared radiation generated by the Fourier transform infrared spectrometer;
means for setting the optical switch to direct infrared radiation from the sample onto the single element detector;
means for passing single element detector signals to a Fourier transforming signal analyzer for spectral analysis of the sample;
means for evaluating said spectral analysis of the sample to decide whether or not further measurements with the two-dimensional array detector should be carried out;
means for switching the optical switch to direct infrared radiation emanating from the sample onto the array detector; and
means for passing pixel by pixel array detector signals to the Fourier transforming signal analyzer for spectroscopic analysis of the sample in two spatial dimensions.

3. The device of claim 2, wherein said single element detector signal passing means and said array detector signal passing means comprise signal switching means connected between said signal analyzer and said array detector and connected between said signal analyzer and said single element detector for transmitting one of said array detector signals and said single element detector signals to said signal analyzer.

4. The device of claim 2, wherein said sample irradiating means comprise translation staging means for horizontal translation of the sample relative to said housing.

5. The device of claim 7, wherein said optical switch comprises a reflecting mirror and means for pivoting said reflecting mirror to reflect the infrared radiation to a first side of the housing, in a first switching position, and to a second side of the housing in a second switching position.

6. The device of claim 5, wherein said reflecting mirror is substantially a planar mirror.

7. The device of claim 2, further comprising optical delineation means for guiding infrared radiation emanating from the sample onto said optical switch.

8. The device of claim 7, wherein said optical delineation means comprise collimating means and focussing means.

9. The device of claim 7, wherein the housing and said optical delineation means define an infrared microscope having a mirror objective.

10. The device of claim 2, further comprising single element detector focussing means disposed in a first optical path between said optical switch and said single element detector for focussing infrared radiation onto said single element detector.

11. The device of claim 2, further comprising array detector focussing means disposed in a second optical path between said optical switch and said array detector for focussing infrared radiation onto said array detector.

12. The device of claim 11, wherein said array detector focussing means define an Ofner telescope.

13. The device of claim 2, further comprising a cryogenic means in thermal contact with said array detector.

14. The device of claim 13, wherein said cryogenic means comprise a liquid nitrogen dewar.

15. The device of claim 2, wherein said array detector comprises at least one of, an MCT-detector, an InSb-detector and an InGaAs detector.

16. The device of claim 2, wherein said single element detector comprises an MCT detector.

17. The device of claim 2, wherein said signal analyzer comprises means for macroscopic imaging.

18. The device of claim 2, wherein said array detector comprises a first array detector with a first spectral sensitivity and a second array detector with a second spectral sensitivity.

19. A method for spectroscopic infrared analysis of defined and selected spatial regions of a sample using a Fourier transform infrared spectrometer, the sample disposed in a housing in which a two-dimensional array detector, a single element detector and an optical switch are also disposed, the optical switch for directing infrared radiation emanating from the sample onto either the array detector or the single element detector, the method comprising the steps of:
a) irradiating the sample with encoded infrared radiation generated by the Fourier transform infrared spectrometer;
b) setting the optical switch to direct infrared radiation emanating from the sample onto the array detector;
c) passing pixel by pixel array detector signals to a Fourier transforming signal analyzer for spectroscopic analysis of the sample in two spatial dimensions;
d) evaluating step c) to decide whether or not further measurements with the single element detector from at least one spatial position of the sample should be carried out, and if so proceeding to step e);
e) switching the optical switch to direct infrared radiation onto the single element detector; and
f) passing single element detector signals to a Fourier transforming signal analyzer for spectral analysis of the sample.

20. A device for Fourier transform infrared spectroscopic analysis of defined and selected spatial regions of a sample using the method of claim 19, the sample disposed in a housing in which a two-dimensional array detector, a single element detector and an optical switch are also disposed, the optical switch for directing infrared radiation emanating from the sample onto either the array detector or the single element detector, the device comprising:
a) means for irradiating the sample with encoded infrared radiation generated by the Fourier transform infrared spectrometer;
b) means for setting the optical switch to direct infrared radiation emanating from the sample onto the array detector;
c) means for passing pixel by pixel array detector signals to a Fourier transforming signal analyzer for spectroscopic analysis of the sample in two spatial dimensions;
d) means for evaluating step c) to decide whether or not further measurements with the single element detector from at least one spatial position of the sample should be carried out;
e) means for switching the optical switch to direct infrared radiation onto the single element detector; and
f) means for passing single element detector signals to a Fourier transforming signal analyzer for spectral analysis of the sample.

21. The device of claim 20, wherein said single element detector signal passing means and said array detector signal passing means comprise switching means connected between said signal analyzer and said array detector and connected between said signal analyzer and said single element detector for transmitting one of said array detector signals and said single element detector signals to said signal analyzer.

22. The device of claim 20, further comprising optical delineation means for guiding infrared radiation emanating from the sample onto said optical switch, wherein the housing and said optical delineation means define an infrared microscope having a mirror objective.

23. The device of claim 20, further comprising array detector focussing means disposed in a second optical path between said optical switch and said array detector for focussing infrared radiation onto said array detector, wherein said array detector focussing means define an Ofner telescope.

24. The device of claim 20, wherein said signal analyzer comprises means for macroscopic imaging.

25. The device of claim 20, wherein said array detector comprises a first array detector with a first spectral sensitivity and a second array detector with a second spectral sensitivity.
